(19) United States
(12) Patent Application Publication
(10) Pub. No.: US 2010/0059447 A1
(43) Pub. Date: Mar. 11, 2010

(54) Products and Methods for Removing Substances from Aqueous Solution

(76) Inventor: Mika Martikainen, Oulu (FI)

Correspondence Address: CANTOR COLBURN, LLP, 20 Church Street, 22nd Floor, Hartford, CT, 06103, US

(21) Appl. No.: 11/884,419

(22) PCT Filed: Feb. 17, 2006
(86) PCT No.: PCT/FI06/50071

§ 371 Date: Mar. 31, 2008

(30) Foreign Application Priority Data
Feb. 17, 2005 (IT) 20055072

(51) Int. Cl. C02F 1/28; C01G 23/053; C01G 23/047; B01J 20/06; B01D 15/00

(52) U.S. Cl. 210/688; 423/610; 423/615; 423/612; 502/406; 210/660; 210/691; 210/502.1

(57) ABSTRACT

The present invention relates to products and methods for removing or recovering substances from aqueous solution. Titanic acid product is used as adsorption material for several substances, for example impurities or contaminants, such as arsenic, lead, fluorine or phosphate. The present invention also relates to a granule for removing substances from aqueous solution and a filter assembly comprising titanic acid or said granule.

### FIELD OF THE INVENTION

The present invention relates to products containing titanic acid and methods for removing substances from aqueous solution. More particularly the present invention relates to water purification and removal of arsenic.

### BACKGROUND OF THE INVENTION

The contamination of water, such as wastewaters or natural waters (groundwater or surface water) has become a major concern in many countries. Several water treatment processes and methods are employed to remove certain types of substances contaminating the water. One specific contaminant is arsenic, which is a semi-metallic element occurring naturally and abundantly throughout the earth. The pure form of arsenic is not usually found in the natural environment but it is rather more commonly found combined with oxygen, chlorine and/or sulfur, therefore referred to as inorganic arsenic.

Arsenic can enter the water supply from natural deposits in the earth or from pollution originated from human activities, such as industry and agriculture. It is also a by-product of copper smelting, mining and coal burning. High arsenic levels may come from certain fertilizers, pesticides, animal feedlots and industrial waste. Once released, arsenic remains in the environment for a long time. High levels of arsenic found in well water are often used to indicate improper well construction or the location or overuse of chemical fertilizers or herbicides. When arsenic is combined with carbon and hydrogen it is called organic arsenic, which is much less toxic as it goes through biotransformation and detoxifies through methylation.

Inorganic arsenic occurs in −3, 0, +3 and +5 oxidation states. The elemental states −3 and 0 are rare and mainly exist in reducing environments whereas oxidation states +3 and +5 are commonly found in water systems depending on the prevailing redox conditions. Under reducing environment arsenite As(III) is found primerily as As(OH)₄⁻, H₃AsO₃, H₂AsO₃⁻, HAsO₃²⁻ and AsO₃³⁻. Different hydrolysis species of arsenate As(V) such as H₃AsO₄, H₂AsO₄⁻, HAsO₄²⁻ and AsO₄³⁻ may be present in water with dissolved oxygen or oxidizing environment.

The toxicity of arsenic to human health ranges from skin lesions to cancer. Several studies have shown that inorganic arsenic can increase the risk of cancers such as lung cancer, skin cancer, bladder cancer, liver cancer, kidney cancer and prostate cancer. The observable symptoms of arsenic poisoning include thickening and discoloration of skin, stomach pain, nausea, vomiting, diarrea, numbness in hands and feet, partial paralysis and blindness. The most known tragedy of arsenic poisoning of drinking water was in Bangladesh, where several thousands of people were killed by arsenic poisoning and millions suffered from the symptoms caused by arsenic. Millions of people are affected by arsenic concentrations exceeding WHO regulations (10 μg/l As) for example in Vietnam, India, Mexico, Argentina and in several areas in USA. In 2002 also U.S. Environmental Protection Agency (USEPA) lowered the maximum contaminant level for arsenic in drinking water from 50 to 10 μg/l (or parts per billion, ppb).

Several methods for treating water to remove contaminating arsenic are known, such as oxidation of As(III), coagulation/co-precipitation, sedimentation, ion exchange, filtration, membrane techniques and adsorption methods. As most arsenic treatment methods are effective only for removing As(V), a pre-treatment by oxidation is applied in order to convert arsenite As(III) to arsenate As(V). Several oxidation methods and oxidants may be used in the oxidation process, such as oxygen, ozone, free chlorine, hypochlorite, permanganate, hydrogen peroxide and Fenton's reagent. Arsenic can be removed from drinking water by means of coagulation. Coagulants such as alum Al₂(SO₄)₃, ferric chloride FeCl₂ and ferric sulfate Fe₂(SO₄)₃.nH₂O are used. Coagulation-based removal processes are effective but however complicated requiring different process equipments and chemical dosing and pH control systems. One method is removal by ion exchange, which is not effective for As(III). In ion exchange the medium is synthetic resin and as the resin becomes exhausted it needs to be regenerated. The waste from this process is concentrated arsenic-containing toxic solution. Membrane techniques such as reverse osmosis, nanofiltration and electrodialysis are capable of removing all kinds of dissolved matter from water, including arsenic. However, the capital and operational costs of the membrane systems are relatively high. Furthermore, membrane techniques produce concentrated arsenic containing waste streams.

Several adsorption methods are known employing adsorption media such as activated alumina, activated carbon, copper-zinc granules, greensand filtration (KMnO₄-coated glauconite), granular ferric hydroxide or iron oxide coated sand.

Adsorption, whether physical or chemical, involves the mass transfer of a soluble species (adsorbate) from solution to the surface of a solid phase (adsorbent). When the adsorbent is a porous media, the transport of adsorbate to adsorbent will occur through four basic steps. First, the adsorbate is transported from the bulk solution to the hydrodynamic boundary layer surrounding the adsorbent. Next the adsorbate must pass through the hydrodynamic boundary layer to the surface of the adsorbent. The thickness of the boundary layer will depend on the velocity of the bulk solution versus the solid phase. In next phase, internal (pore) transport, an intraparticle transport by molecular diffusion through the solution in the pores (pore diffusion) or by diffusing along the adsorbent surface (surface diffusion) after adsorption takes place. In final step (adsorption) the adsorbate attach onto the adsorbent surface at available sites. This step is very rapid. Therefore one of the preceding diffusion steps will control the rate of mass transfer.

Generally adsorption is a mechanism for binding the desired impurities or contaminants. Adsorption can be utilised for example as continuously (e.g. by filtrating the water to be purified through a layer of the adsorptive media) or as batch system wherein the adsorptive media must be separated after the purification by filtration, sedimentation or by any other suitable means. Adsorption process may also rely on a combination of adsorption, precipitation/co-precipitation, ion exchange and filtration. However, the primary removal mechanism in each process is adsorption.

Activated alumina, Al₂O₃, having good sorptive surface is an effective media for arsenic removal and therefore it is one of the most commonly used media to remove arsenic from drinking water. In activated alumina adsorption the arsenic present in water is adsorbed on the surfaces of activated alumina grains. Eventually the adsorption column becomes saturated. Regeneration of saturated alumina is carried out by exposing the medium to 4% NaOH, either in batch or by flow through the column resulting in high arsenic contaminated caustic wastewater. Finally activated alumina is spent and one needs to handle aluminium hydroxide sludge having high arsenic concentration.

Titanium compounds, such as titanium dioxide (TiO₂) (for example as anatase or rutile) or titanium hydroxide, are materials used for removal of arsenic in ion exchange, filtration and adsorption applications. In U.S. Pat. No. 6,383,395 a media is used to remove species from aqueous solution by passing the solution into contact with said media, which may contain titanium hydroxide. Said media is ion exchange-like media which has also the ability to remove non-ionic species.

WO 03/068683 discloses a method for producing a surface-activated crystalline titanium oxide product by heating at 105-300° C. which product is used in methods to remove dissolved inorganic contaminants from dilute aqueous streams by suspending the product in an aqueous stream or by filtering an aqueous stream through a bed of the product. In particular said titanium oxide product is effective in adsorbing arsenite and arsenate and dissolved metals. In a preferred embodiment said surface-activated crystalline titanium oxide product comprises nano-crystalline anatase.

U.S. Pat. No. 4,313,844 discloses an inorganic ion exchanger prepared by kneading a blend of anatase or amorphous titanic acid with inorganic acid selected from the group consisting of sulphuric acid, hydrochloric acid and phosphoric acid and thereafter heat treating the products at a temperature of 50-500 ° C. for 3-19 hours. Said ion exchanger has high strength in water and is suitable for use in the removal or the concentration and recovery of injurious or beneficial materials contained in water. Said titanic compounds employed are represented by the formula TiO₂.nH₂O and they are used as raw material when preparing the ion exchanger end product by heating. In all the examples the temperature used was 300° C.

WO 02/082463 discloses an agent comprising titanium oxide hydrate (80-95% w/w) with bonding agent made from vinyl acetate and hydrogen peroxide to remove heavy metals, metals, arsenic, uranium and radium from polluted waters.

GB 1469042 discloses a collector for dissolved uranium which contains a titanium compound (0.5-10% w/w) with high polymer, such as a vinyl ester of fatty acid, maleic acid or maleic anhydride.

GB 495 692 discloses a process for the removal of iron from solutions of aluminium salts, which comprises treating said solutions with hydrous titanium dioxide. In the example the process was carried out at high temperatures, such as 105° C.

U.S. Pat. No. 6,919,029 discloses a method for producing a surface-activated crystalline titanium oxide product for removal of dissolved contaminant from aqueous streams, comprising the steps of preparing a titanium oxide precipitate from a mixture comprising at least one hydrolysable titanium compound, selecting a drying temperature to provide capacity and high rate of adsorption with respect to the dissolved contaminants, and drying said titanium oxide precipitate at said drying temperature for less than two hours wherein said method does not include a calcining step. Further a nano-crystallinen anatase product is disclosed consisting predominantly, if not entirely, of anatase crystals having crystallite diameter in the range of about 1 to about 30 nm.

This and all the other documents referred are incorporated herein by reference.

There is still need for simple, economical and efficient methods and materials for water treatment to remove or recover substances from aqueous solutions. In particular the material should be able to remove contaminating substances such as arsenic which are present in low levels. The amount of waste should be minimized and the material should be usable in several types of arrangements. Also, the use of high temperatures or extra reagents or other agents in the preparation of the material as well as in the water treatment process should be avoided.

### SUMMARY OF THE INVENTION

The present invention is based on the discovery that titanic acid product specifically prepared by seeding with nuclei is very efficient as adsorption material for several substances, such as impurities or contaminants, such as arsenic, lead, fluorine or phosphate. When compared to commercially available titanium oxide products said titanic acid product was several times better. Further, said titanic acid product could remove both As(III) and As(V) efficiently without the need for first oxidizing As(III) to As(V). Further, the use of titanic acid product as adsorption material does not require elevated temperatures for efficient adsorption. The preparation of materials containing titanic acid products of the invention is simple and requires no heating, chemical treatment or the use of any binding agents.

It is characteristic for the present invention what is disclosed in the independent claims. Some embodiments of the invention are described in the dependent claims.

One aspect of the present invention provides a product for water purification comprising a titanic acid product having general formula TiO₂.nH₂O, wherein n=1 or 2, obtained by a process wherein titanic acid is precipitated from acidic hydrolysable titanium salt solution and said hydrolysable titanium salt solution is seeded with nuclei in the precipitation step in order to control the formation of the structure of said titanic acid product.

Another aspect of the present invention provides a product for water purification comprising a titanic acid product having general formula TiO₂.nH₂O, wherein n=1 or 2, containing seeded nuclei which have controlled the structure of the titanic acid product.

Another aspect of the present invention provides the use of said titanic acid product for removing substances from aqueous solution, such as removal of contaminants.

Another aspect of the present invention provides a granule for use in said removal of substances from aqueous solution, said granule comprising said titanic acid product. Granules from titanic acid product can be produced by any known granulation method.

Still another aspect of the present invention provides the use of said granule for removing substances from aqueous solution, such as for removal of contaminants.

Still another aspect of the present invention provides said granule further comprising non-watersoluble iron(III) compound and the use thereof.

Still another aspect of the present invention provides a method for removing substances from aqueous solution by contacting said solution with said titanic acid product.

Still another aspect of the present invention provides a method for removing substances from aqueous solution by contacting said solution with said granule.

Still another aspect of the present invention provides a filter assembly for removing substances from aqueous solution, said filter assembly containing said titanic acid product or said granule.

### DEFINITIONS

In the literature also other titanium compounds, such as titanium dioxide (TiO₂) were earlier sometimes called titanic acids. However, the “titanic acids” herein refer to aggregates of small titanium dioxide particles, for example of diameter approximately 2-3 nm or less (each aggregate is built up of more than one titanium dioxide molecule), that have mass fractal structure in ortotitanic acid (alpha titanic acid) and surface fractal structure in metatitanic acid (beta titanic acid) (Jalava, J., University of Turku, Finland, 2000). Many references denote them as Ti(OH)₄ or TiO₂.2H₂O and TiO(OH)₂ or TiO₂.H₂O, respectively. It has been proven that water in the structure is bound either to surface of the crystallite structure as water or as hydroxyl groups. Depending on the manufacturing process the titanic acid structure can have some sulfate or chloride residues bound to the surface of the crystals. In the present invention especially sulfate based process has been used resulting titanic acids having sulfates in the surface of the crystallites. When titanic acids are neutralized with alkaline the structure can also contain alkaline parts, for example Na from NaOH neutralization.

“Nucleation” or “nuclei” refer to non-soluble stable nanosized solid particles, such as ones having rutile or anatase crystal structure. “Nuclei” control the hydrolyzation and precipitation of solid titanic acid from acidic titanium salt solution in a nucleation process resulting more homogenous titanic acid precipitate and a specific structure.

“Aqueous solution” as used herein refers to any solution containing water. Preferably said aqueous solution is any solution containing sufficient amount of water phase to be used in the current invention. Said aqueous solution may be for example water, ground water, waste water, industrial water, sludge or solids suspension, pulp suspension or any other suitable aqueous solution.

“Substances” to be removed from an aqueous solution as used herein refer to any substance present in the solution. Such substances may be harmful or beneficial substances, for example contaminants or reaction products or by-products. Non-limiting examples of said substances are elements and compounds thereof, such as inorganic compounds, organometallic compounds, organic compounds, elements in their different oxidation states and the like. In one embodiment “removing substances from aqueous solution” refers to water purification.

“Contaminant” as used herein refers to any contaminating substances in said aqueous solution. Such contaminants may be for example metal or heavy metal ions, halogens, nitrogen compounds such as nitrates, phosphorous compounds such as phosphates, sulfurous compounds such as sulfides and sulfites or small organic compounds with low molecular weight. Non-limiting examples of said metals, heavy metals and other contaminating substances are Al, Sb, As(III), As(V), P, Ba, Cd, Ce, Cr, Co, Cu, Ga, Au, Fe, Pb, Mn, Hg, Mo, Ni, Pt, Se, Ag, Sn, W, U, Ra, Sr, Te, Zn and F and oxidation states and compounds thereof. Said contaminants include also organic compounds such as low molecular weight organic arsenic compounds monomethylarsonic acid, dimethylarsinic acid and phenylarsonic acid. Preferred contaminants include arsenic compounds such as As(III) and As(V).

“Granule” as used herein refers to a small compact particle of substance, especially one of a number of particles forming a larger unit.

### DETAILED DESCRIPTION OF THE INVENTION

Titanic acid is generally used as raw material for manufacturing pigments, catalysts and ceramics as well as in the electronics industry. Titanic acid is powdered white inorganic acid, which is derived from an acid solution of titanates. The titanic acid product of the present invention is a homogenic mass having a specific nanocrystalline structure obtained in the preparation process using nuclei as described below. In one embodiment the nuclei are anatase nuclei. In another embodiment the nuclei are rutile nuclei. The nuclei, or crystal seeds, control the formation of the specific titanic acid structure in the precipitation step of the manufacturing method. This specific structure gives the product the better adsorption properties when compared to conventional products, eg. TiO₂ with anatase crystal structure or TiO₂ with rutile crystal structure. The specific surface area of the product is high when compared to the known products, such as in the range of 100-400 m²/g, preferably 250-350 m²/g.

The formation and preparation of several titanium compounds are disclosed in the thesis book “Formation of TiO₂ Pigment Particles in the Sulfate Process—A Methodological Study” (Jalava, J., University of Turku, Finland, 2000) and in the related articles (e.g. Jalava et al., Structural Investigation of Hydrous Titanium Dioxide Precipitates and their Formation by Small Angle X-ray Scattering. Ind. Eng. Chem. Res. 2000, 39, 349-361).

The hydrolysis of titanium(IV) solutions and especially the structure of the precipitates are of importance in manufacturing of TiO₂ pigments by the sulfate process. The precipitation from both the sulfate and the chloride solutions is a part of the process. The latter is used to prepare nuclei for the thermal precipitation of the sulfate solutions. In sulfate-containing solutions particles of only the anatase structure are formed. The nuclei are important because they speed up and regulate the precipitation in sulfate solutions. In producing rutile TiO₂ pigments these nuclei are also the agents needed in the calcination to regulate the transformation of anatase crystallites to rutile and to participate in the final formation of the pigment particles. The addition of ammonia or alkali hydroxide into the solution of tetravalent titanium salt yields an X-ray amorphous product commonly called ortotitanic acid or alpha titanic acid. It is a white gelatinous and highly hydrous precipitate, which is readily soluble in dilute acids and easily peptized by dilute alkalis and suitable salts to give stable sols. Opposite to this is the thermal precipitation or ageing ortotitanic acid to give a product referred to as metatitanic acid, or beta titanic acid. It is a granular, relatively insoluble, but slightly peptizable substance. It is thought that the titanic acids, like stannic acids, are hydrous oxides whose properties are essentially determined by the differing sizes of the primary particles of which they are made. The size of the crystallite particles in metatitanic acid is about 5-10 nm.

There is very little evidence concerning the possible particle or crystallite size of the X-ray amorphous ortotitanic acid prepared from aqueous solutions of titanium tetrachloride. Kormann et al. prepared, by adding cold (−20 ° C.) TiCl₄ to water, 2.0 nm anatase TiO₂ crystallites determined by TEM (Kormann, C.; Bahnemann, D. W.; Hoffmann, M. R. Preparation and Characterization of Quantum-size Titanium Dioxide. J. Phys Chem. 1988, 92, 5196-5201). They did not report the X-ray diffraction diagram of the crystallites, but these are likely to be X-ray amorphous according to the studies of Wright et al. (Wright, A. F.; Mukherjee, S. P.; Epperson, J. E. Nature of the 30 Å Texture in Polymeric TiO₂ Gel. J. Phys., Colloq. 1985B, 46, C8-521-525.) In their studies by small angle neutron scattering (SANS) the amorphous solid prepared by hydrolytic polycondensation of titanium isopropoxide with water reveals a texture on a length scale of 3 nm.

“Titanic acids” have been identified such that ortotitanic acid is mass fractal aggregates and metatitanic acid correspondingly surface fractal aggregates of small titanium dioxide particles (e.g. anatase, rutile or brookite) (Jalava et al., Ind. Eng. Chem. Res. 2000, 39, 349-361). Many references denote them as Ti(OH)₄ or TiO₂.2H₂O and TiO(OH)₂ or TiO₂.H₂O, respectively (Barksdale, J.: Titanium. Its occurrence, Chemistry and Technology, The Ronald Press Company, New York 1966, pp. 78, 256-316; Gmelins Handbuch der anorganichen Chemie, (8th edition, System No. 41, “Titan”, Werlag Chemie 1951, 1971 (photo mechanical reproduction of the 1951 edition), pp. 230, 256-258). However, Weiser and Milligan (Weiser, H. B.; Milligan, W. O. X-ray Studies on the Hydrous Oxides. IV Titanium Dioxide. J. Phys. Chem. 1934, 38, 513-519) have considered that they, like the stannic acids, are rather hydrous oxides whose properties are essentially determined by the differing size of the primary particles that constitute the sample. This certainly appears to be one of the essential factors. A second affecting factor now seems to be the location of the particles within the structure, i.e. the fractality. Thus it is relatively easy to determine that the loose structure of the mass fractal aggregates results in its relatively easy solubility and the X-ray amorphous state found for ortotitanic acid. On the other hand, the more compact structure of metatitanic acid is consistent with its determined nano crystallinity and relative insolubility. The transformation from ortotitanic acid to metatitanic acid upon ageing is obviously a consequence of the restructuring of the primary titanium dioxide particles towards the close-packed porous structure.

For preparing the titanic acid product of the invention any suitable method may be used, such as the sulfate or the chloride processes, which are well-known to a person skilled in the art. The sulfate process is disclosed for example in U.S. Pat. No. 6,919,029 and it comprises digesting titanium ore with sulfuric acid and leaching with water or dilute acid to produce a solution of titanium sulfate and iron sulfates (which is generally called “black liquor”). The solution is cooled down and iron sulfates are separated. Pure titanium sulfate solution is hydrolyzed and titanic acid is precipitated. According to the invention in the precipitation step the crystal seeds, i.e. anatase or rutile nuclei, are used to control the formation of the final product. The amount of nuclei to be used is generally in the range of 1-10%, preferably 1-3% (w/w) of the final product. Also the neutralization step of the final product is optional. Titanic acid precipitate is filtrated and washed, followed up with drying. Drying can be done at any known method.

In the chloride process a similar seeding with nuclei can be utilized in the step where the hydrolyzed titanium compound is precipitated to obtain the titanic acid product of the invention.

The hydrolysable titanium compound to be hydrolyzed may be any suitable compound such as titanium trichloride, titanium tetrachloride, titanyl sulfate, titanium sulfate, titanium oxysulfate, titanium iron sulfate, titanium oxychloride or any titanium alkoxide. Titanium tetrachloride and titanyl sulfate are preferred.

In the present invention several titanium compounds were tested for the removal of different substances. It was noticed that titanic acid compounds work extremely well in adsorption of arsenic from waters. Especially it was noticed that titanic acid has better efficiency than a commercial arsenic adsorption material “surface-activated anatase TiO₂” (prepared according to U.S. Pat. No. 6,919,029). When titanic acid product of the present invention was tested, it was noticed that it is several times better than the surface-activated anatase form TiO₂.

Further, when different TiO₂ compounds were tested for removal of As(III) and As(V), it was noticed that the ability of these products to remove As(III) from the solution was low when compared to that of titanic acid product of the present invention. This is advantageous since when using said titanic acid product the step of oxidizing As(III) to As(V) to get efficient adsorption can be omitted. This will save time, money and the environment.

One embodiment of the present invention provides the use of said titanic acid product for removing substances from aqueous solution. Said substances may be harmful or beneficial substances. In one embodiment said substances are contaminants and their removal is desired (i.e. water purification). Said contaminants may be any known contaminants, such as metal and heavy metal ions, halogens, nitrogen compounds, phosphorous compounds, sulfurous compounds or small organic compounds. In another embodiment said substances are beneficial or useful substances, such as a reaction product to be recovered from the solution.

Titanic acid is capable of removing various substances from an aqueous solution. Non-limiting examples of such substances are Al, Sb, As(III), As(V), P, Ba, Cd, Ce, Cr, Co, Cu, Ga, Au, Fe, Pb, Mn, Hg, Mo, Ni, Pt, Se, Ag, Sn, W, U, Ra, Sr, Te, Zn,

F, humic acid and compounds thereof. Preferred substances to be removed in the present invention are arsenic in different oxidation states and compounds thereof, such as As(III) or As(V), and lead, phosphate, fluorine, mercury, chromium, zinc or cadmium. As(III) is especially preferred since when using titanic acid to recover or remove As the generally used oxidation step [As(III)→*As(V)] can be omitted.

Another embodiment of the present invention provides a granule for removing substances from aqueous solution, said granule comprising titanic acid product of the invention. Preferably said granule contains no binding agents or the like, such as vinyl ester of fatty acid, maleic acid or maleic anhydride; or vinyl acetate, polymers, plastics or other organic compounds described in the art. In still another embodiment said granule further comprises non-soluble iron, for example as FeOOH or ferric hydroxide. In still another embodiment the iron is in the form of iron (III) hydroxide, iron (III) oxide hydroxide, iron (III) oxide or combinations thereof.

In one embodiment the granule may be substantially composed of titanic acid product or titanic acid product and iron i.e. the titanic acid (or titanic acid and iron) content is very high (e.g. >95% w/w), but some minor impurities may be found. Said granule may be prepared by any suitable method that are well known in the art, for example by the compacting method. Preferably said granule is prepared without heating treatment and it is stable in water. No extra reagents, such as inorganic acids or the like, or chemical treatments with said reagents, are necessary in the preparation of the granule. The granule may be used as material for filters or the like and it is easy to recover and regenerate.

Granules containing titanic acid product were tested for the removal of As and they were discovered to be still able to bind As from an aqueous solution. When titanic acid product was further combined with iron (e.g. FeOOH), it was noticed that the capability of adsorbing As was significantly higher. As a physically rougher product FeOOH will increase the porosity of the granule thus improving the adsorption capability of the granule. On the other hand, iron itself also acts as an adsorber. Further, FeOOH is less expensive product and it will lower the production costs of granulated titanic acid adsorber.

Another embodiment of the present invention provides a method for removing substances from aqueous solution, comprising the step of contacting said solution with titanic acid product of the invention. In still another embodiment said titanic acid product is in the form of a granule or a granule further comprising iron, as described above.

Still another example of the present invention provides a filter assembly for removing substances from aqueous solution said assembly comprising a casing containing titanic acid product of the invention. Preferably the casing contains also inlet and outlet for said aqueous solution. The casing may be any suitable material, such as metal, glass or plastic or combinations thereof. The filter assembly may be any kind of filter, packed column, reactor or casing known in the art comprising titanic acid product as an active agent, for example a generally known filter of flow-through type wherein the solution to be treated (influent) flows in from the first end of the filter and out from the second end of the filter (effluent). This kind of filter may be used for example in continuous water filtration and purification. Further, the filter may be for example for small scale use, such as for household water purification (centralised treatment or point-of-use), or for large scale use, such as a filtration system for drinking water manufacturing. In still another embodiment said titanic acid is in the form of a granule or a granule further comprising iron, as described above.

### Examples

Preparation of the Titanic Acid Product of the Present Invention with Anatase Seeds

The titanic acid product produced in the sulfate process described next was used in the tests below. Also other suitable processes may be utilized, such as the well known chloride process. First ilmenite is dissolved in sulfuric acid. Trivalent iron is reduced to the divalent form using scrap iron metal as the reducing agent. The reduced solution is settled and filtered to remove unreacted solids. The iron content is considerably reduced by the cooling-induced crystallization and subsequent removal of crystals of FeSO₄.7H₂O. The solution is concentrated by vacuum evaporation to an optimal titanium concentration for precipitation. Crystal seeds (either anatase or rutile structure) are used in the precipitation of titanic acid from the acidic titanium salt liquor. The precipitate is separated by filtration from the filtrate (see Jalava, J-P. Formation of TiO₂ pigment particles in the sulfate process—a methodological study. PhD dissertation, University of Turku, 2000, Karvinen, S. Experimental and theoretical studies on doped and undoped rutile and anatase TiO₂ for photocatalyst and pigment use. PhD dissertation, University of Joensuu, 2003). The separated precipitate may or may not be neutralized with NaOH. Then, the TiO₂ precipitate is dried and packaged. Specific surface area of the final product is 100-400 m²/g.

The titanic acid products of the invention called titanic acids A, B and C were seeded with anatase nuclei as described above. The products called titanic acids D and E were seeded with rutile nuclei with the method described above. The amount of nuclei used herein was about 3% (w/w) of the total product.

Preparation Without Anatase Seeds (Reference Product 1)

The pH value of 1.5 dm³ TiOSO₄ solution (Ti content calculated as TiO₂ 70 g/dm³) was adjusted to 1 with NaOH. The solution was heated to 90° C. and kept at that temperature for 30 min. pH was adjusted to 6.5 with NaOH. The precipitate was filtered and washed. The drying was done at 60° C. Specific surface area of the final product was 240 m²/g.

The following titanium chemicals were tested for adsorption efficiency (table 1.). Three different types of titanic acid products according to the present invention seeded with anatase were used (herein called titanic acid A, B and C). The differences between titanic acids B and C are in the sodium content deriving from the alkali used in the neutralization of the titanic acid. The titanic acid B is so called low sodium grade neutralized with ammonia and the C is the “normal” i.e. higher sodium containing grade neutralized with NaOH. The titanic acid seeded with rutile nuclei were acidic (E) or neutralized with NaOH (F). The reference product 1 was prepared without seeds from titanyl sulfate as described above and it can be used as reference to the anatase-seeded titanic acids A, B and C. Reference product 2 was prepared similarly from titanium tetrachloride and it can be used as reference to the rutile-seeded titanic acids E and F. All the adsorption tests were conducted in room temperature.

TABLE 1
Different titanium chemicals tested

| | Specific surface | Crystal | |
|---|---|---|---|
| Grade | area (m²/g) | size (nm) | Composition |
| DOW Chemicals | >100 (see | 20-30 | Surface activated |
| Adsorbsia | U.S. Pat. No. | | anatase TiO₂ |
| | 6,919,029) | | |
| Kemira ANX A | 100 | 20 | TiO₂ Anatase, acidic |
| Kemira ANX N | 100 | 20 | TiO₂ Anatase, neutral |
| Titanic acid A | 250-300 | 5 | Titanic acid, acidic |
| Titanic acid B | 300-350 | 5 | Titanic acid, neutral |
| Titanic acid C | 300-350 | 5 | Titanic acid, neutral |
| Reference | 240 | 6 | Titanic acid from |
| product 1 | | | titanyl sulfate, |
| | | | no seeds |
| Titanic acid E | 250-350 | 5 | Titanic acid, acidic |
| Titanic acid F | 250-350 | 5 | Titanic acid, neutral |
| Reference | 143 | 4 | Titanic acid from |
| product 2 | | | titanium tetrachloride, |
| | | | no seeds |

### Example 1

### Comparison of Titanium Oxide Products for Arsenic Removal

For the tests of arsenic removal a solution of 1 mg/l arsenic was prepared into ion exchanged water using commercial standard As-solution from Reagecon. In each test 135 mg/l of adsorbent product to be tested was added to arsenic-containing water and the pH was adjusted to 6.2 with 10% NaOH. After this the solution was mixed for 1 hour before filtration through 0.22 μm membrane. As was analyzed from the filtrate using AAS FIAS hybrid method (FIAS-AAS, Determination of arsenic—Atomic absorption spectrometric method [hydride technique] SFS-EN ISO 11969). The removal of arsenic (%) was calculated from the ratio of analyzed remaining As-concentration and the influent water As-concentration.

The capability of the titanium dioxide products to bind As(III) was tested same way as for As(V). It is generally known that removal of As(III) from the water without separate oxidising step (As(III)→As(V)) is difficult.

TABLE 2
Removal of As(V) with different brands of titanium dioxide

| | Product tested | As removal (%) |
|---|---|---|
| As(V) | Kemira ANX N | 51.0 |
| As(V) | Kemira ANX A | 65.0 |
| As(V) | DOW Adsorbsia | 20.0 |

TABLE 3
Removal of As(III) with different brands of titanium dioxide

| | Product tested | As removal (%) |
|---|---|---|
| As(III) | Kemira ANX N | 39.0 |
| As(III) | Kemira ANX A | 27.0 |
| As(III) | DOW Adsorbsia | 12.0 |

### Example 2

### Comparison of Titanic Acid Products for Arsenic Removal

Titanic acid products were tested according to example 1. The results are shown in tables 4 and 5. It can be concluded from the results that titanic acid products bind arsenic substantially better than titanium dioxide products. Further, their capability to bind As(III) is superior. The reference products wherein no seeds were used in the preparation, were not as efficient when tested on As(V).

TABLE 4
Removal of As(V) with different types of titanic acid

| | Product tested | As removal (%) |
|---|---|---|
| As(V) | Titanic acid A | 98.3 |
| As(V) | Titanic acid B | 90.0 |
| As(V) | Titanic acid C | 93.2 |
| As(V) | Reference product 1 | 48.0 |
| As(V) | Titanic acid D | 70.0 |
| As(V) | Titanic acid E | 65.0 |
| As(V) | Reference product 2 | 29.0 |

TABLE 5
Removal of As(III) with different types of titanic acid

| | Product tested | As removal (%) |
|---|---|---|
| As(III) | Titanic acid A | 90.0 |
| As(III) | Titanic acid B | 67.0 |
| As(III) | Titanic acid C | 61.0 |

### Example 3

### pH Optimum for Arsenic Removal

The pH of the water to be purified may vary quite a lot. The adsorbents generally have limited working pH range. To find out the optimum ranges of different titanic acids a series of experiments were conducted with waters of different pHs containing 1.0 mg/l arsenic.

Solutions of As(V) were prepared with commercial arsenic standard (Reagecon) into ion exchanged water. The concentration of the As(V) solutions were 1.0 mg/l. The pHs of the solutions were adjusted to studied pH in range pH 4-9 with 10% NaOH.

In the arsenic removal test 135 mg/l of the titanic acid to be studied (titanic acid A, titanic acid B or titanic acid C) was used. In each test titanic acid was added to arsenic-containing water with desired pH (adjusted with 10% NaOH). After this the solution was mixed for 1 hour before filtration through 1.2 μm membrane. As was analysed from the filtrate using AAS FIAS hybrid method (FIAS-AAS, Determination of arsenic—Atomic absorption spectrometric method [hydride technique] SFS-EN ISO 11969). The removal of arsenic (%) was calculated from the ratio of analyzed remaining As-concentration and the outlet water As-concentration.

The results in table 6 show that titanic acid operates at wide pH range. Titanic acid type A (acidic titanic acid) has especially wide pH range.

TABLE 6
Removal of As at different pHs with different types of titanic acid

| | Titanic acid A | Titanic acid B | Titanic acid C |
|---|---|---|---|
| pH | As removal (%) | As removal (%) | As removal (%) |
| 4 | 99.1 | 99.4 | 99.3 |
| 5 | 99.3 | 98.1 | 96.8 |
| 6 | 99.0 | — | 91.6 |
| 7 | 99.1 | 82.0 | 78.0 |
| 8 | 99.3 | 83.0 | 70.0 |
| 9 | 99.1 | 71.0 | 52.0 |

### Example 4

### Removal of Lead

The ability of titanic acid to remove also other substances was tested. A solution containing lead (0.85 mg/l) as a contaminant was prepared. 300 mg/l of solid titanic acid was added to the solution and it was reacted for one hour. After this the sample was filtrated to separate the solid titanic acid and the filtrate was analysed for the lead concentration.

TABLE 7
Removal of lead with different types of titanic acid

| Titanic acid | Pb concentration after 1 h treatment |
|---|---|
| Titanic acid A | <0.1 mg/l |
| Titanic acid B | <0.1 mg/l |
| Titanic acid C | <0.1 mg/l |

Table 7 shows that all the tested titanic acids adsorb lead from aqueous solution. Thus, titanic acid can be used to purify lead-containing water.

### Example 5

### Removal of Different Heavy Metals

The ability of titanic acid to remove also other heavy metals than lead was tested. A solution containing investigated metal (1.0 mg/l) as a contaminant was prepared. 150 mg/l of solid titanic acid (titanic acid type C) was added to the solution and it was reacted for one hour. After this the type sample was filtrated to separate the solid titanic acid and the filtrate was analyzed for the residual metal concentration.

TABLE 8
Removal of different heavy metals with titanic acid type C

| Tested heavy metal | Metal concentration after 1 h treatment |
|---|---|
| Hg | <0.1 mg/l |
| Cr | <0.1 mg/l |
| Zn | <0.1 mg/l |
| Cd | <0.1 mg/l |

Table 8 shows that titanic acids can adsorb different heavy metals from aqueous solution. Thus, titanic acid can be used to purify water containing heavy metals.

### Example 6

### Removal of Phosphor

A solution containing phosphate (4.00 mg/l calculated as phosphor) as contaminant was prepared. 600 mg/l of solid titanic acid was added to the solution and it was reacted for one hour. After this the sample was filtrated to separate the solid titanic acid and the filtrate was analyzed for the phosphor concentration with Dr. Lange's phosphor tubes and Cadas 30 spectrophotometer.

TABLE 9
Removal of phosphor with different types of titanic acid

| Titanic acid | P concentration after 1 h treatment |
|---|---|
| Titanic acid A | 0.06 mg/l |
| Titanic acid B | 1.45 mg/l |
| Titanic acid C | 1.59 mg/l |

### Example 7

### Removal of Fluorine

A solution containing NaF (2.0 mg/l calculated as fluorine) as contaminant was prepared. 600 mg/l of solid titanic acid was added to the solution and it was reacted for one hour. After this the sample was filtrated to separate the solid titanic acid and the filtrate was analyzed for the fluorine concentration.

TABLE 10
Removal of fluorine with different types of titanic acid

| Titanic acid | F concentration after 1 h treatment |
|---|---|
| Titanic acid A | 2.0 mg/l |
| Titanic acid B | 0.2 mg/l |
| Titanic acid C | 1.5 mg/l |

In table 10 it can be seen that the titanic acid type B removes fluorine especially well. Acidic titanic acid does not bind fluorine at the pH tested.

### Example 8

### Removal of Organic Compounds

Humic acid is an organic compound existing in natural raw waters. A synthetic humic acid solution (containing humic acid calculated as total organic carbon TOC 12.0 mg/l) was prepared. 500 mg/l of solid titanic acid type C was added to the solution and it was reacted for 2, 20 and 30 min. After this the samples were filtrated to separate the solid titanic acid and the filtrate was analyzed for the TOC concentration.

TABLE 11
Removal of organic compound with titanic acid type C

| Reaction time | TOC concentration |
|---|---|
| 2 min | 6.0 mg/l |
| 20 min | 4.2 mg/l |
| 30 min | 3.9 mg/l |

In table 11 it can be seen that the titanic acid type C can remove organic compounds with fast reaction rate.

### Example 9

### Titanic Acid Product Granules

Titanic acid product was granulated by compacting method. In the compactor the mass to be granulated is forced with extruder between two rolling cylinders where it will be pressed into a sheet. The sheet is crushed with hammer crusher and the crushed granules are sieved with brake sieve. The pressure force affects the firmness of the granule product. The force may be adjusted by controlling the distance of the cylinders and the rotative velocities of the cylinders and the extruder. The granule size of the product can be defined with a sink gill net.

After the crushing the 1-2 mm fraction was separated and tested for arsenic removal as described in example 1, however using 45-300 mg/l of titanic acid granule.

TABLE 12
Removal of As with 1-2 mm granulated titanic acid type C

| Titanic acid C granule 1-2 mm (mg/l) | Removal of As (%) |
|---|---|
| 45 | 6 |
| 90 | 13 |
| 300 | 35 |

In table 12 it can be seen that granulated titanic acid is still capable of binding arsenic from aqueous solution even as this large granular material. Removal rate of arsenic can be improved by increasing dosage of granular titanic acid. As a granulated product the titanic acid adsorber is easy to separate from the aqueous solution after usage. Further, the granulated product may be used in several kinds of filters, for example for continuous water filtration and purification.

### Example 10

### Granules of Titanic Acid Product and Iron

A mixture of titanic acid type C and FeOOH (mass ratio 3:1) was granulated as described in example 9. FeOOH was prepared as described in EP 0 997 436 A1.

After the crushing the 1-2 mm fraction was separated and tested for arsenic removal as described in example 1, however using 45-300 mg/l of titanic acid/iron granule.

TABLE 13
Removal of As with 1-2 mm granulated titanic
acid type C titanic acid and iron

| Titanic acid C:FeOOH 3:1 | |
|---|---|
| granule 1-2 mm (mg/l) | Removal of As (%) |
| 45 | 21 |
| 90 | 31 |
| 300 | 82 |

In table 13 it can be seen that granulated titanic acid combined with iron is capable of binding arsenic from aqueous solution and the presence of the iron further improves the binding capacity.

1. A product for water purification comprising a titanic acid product having the general formula TiO₂.nH₂O, wherein n=1 or 2, obtained by a process wherein titanic acid is precipitated from an acidic hydrolysable titanium salt solution and said hydrolysable titanium salt solution is seeded with nuclei in the precipitation step in order to control the formation of the structure of said titanic acid product.

2. The product for water purification of claim 1, wherein the nuclei are anatase nuclei.

3. The product for water purification of claim 1, wherein the nuclei are rutile nuclei.

4. The product for water purification of claim 1, wherein the amount of nuclei is 1-10% (w/w) of the total titanic acid product.

5. The product for water purification of claim 4, wherein the amount of nuclei is 1-3% (w/w) of the total titanic acid product.

6. The product for water purification of claim 1, wherein said hydrolysable titanium salt is titanium tetrachloride or titanyl sulfate.

7. The product for water purification of claim 1, having a surface area of 100-400 m²/g.

8. The product for water purification of claim 7, having a surface area of 250-350 m²/g.

9. A product for water purification comprising titanic acid product having the general formula TiO₂.nH₂O, wherein n=1 or 2, containing seeded nuclei which have controlled the structure of the titanic acid product.

10. The product for water purification of claim 9, wherein the nuclei are anatase nuclei.

11. The product for water purification of claim 9, wherein the nuclei are rutile nuclei.

12. The product for water purification of claim 9, wherein the amount of nuclei is 1-10 (w/w) of the total titanic acid product.

13. The product for water purification of claim 9, having a surface area of 100-400 m²/g.

14. The product for water purification of claim 13, having a surface area of 250-350 m²/g.

15. Use of a titanic acid product for removing substances from aqueous solution; wherein the titanic acid product has the general formula TiO₂.nH₂O, wherein n=1 or 2, and is obtained by a process wherein titanic acid is precipitated from an acidic hydrolysable titanium salt solution and said hydrolysable titanium salt solution is seeded with nuclei in the precipitation step in order to control the formation of the structure of said titanic acid product.

16. The use of claim 15, wherein the nuclei are anatase nuclei.

17. The use of claim 15, wherein the nuclei are rutile nuclei.

18. The use of claim 15, wherein the amount of nuclei is 1-10% (w/w) of the total titanic acid product.

19. The use of claim 18, wherein the amount of nuclei is 1-3% (w/w) of the total titanic acid product.

20. The use of claim 15, wherein said hydrolysable titanium salt is titanium tetrachloride or titanyl sulfate.

21. The use of claim 15, wherein the product has surface area of 100-400 m²/g.

22. The use of claim 21, wherein the product has surface area of 250-350 m²/g.

23. The use of claim 15, wherein said substances comprise contaminants.

24. The use of claim 23, wherein said contaminants comprise metal or heavy metal ions, halogens, nitrogen compounds, phosphorous compounds, sulfurous compounds, or small organic compounds with low molecular weight.

25. The use of claim 24, wherein said contaminants comprise Al, Sb, As(III), As(V), P, Ba, Cd, Ce, Cr, Co, Cu, Ga, Au, Fe, Pb, Mn, Hg, Mo, Ni, Pt, Se, Ag, Sn, W, U, Ra, Sr, Te, Zn, F, humic acid, or compounds thereof.

26. The use of claim 25, wherein said contaminants comprise As(III) or As(V).

27. A granule for removing substances from aqueous solution, wherein said granule comprises a titanic acid product having the general formula TiO₂.nH₂O, wherein n=1 or 2, obtained by a process wherein titanic acid is precipitated from acidic hydrolysable titanium salt solution and said hydrolysable titanium salt solution is seeded with nuclei in the precipitation step in order to control the formation of the structure of said titanic acid product.

28. The granule of claim 27, further comprising non-soluble iron.

29. The granule of claim 28, wherein said non-soluble iron is iron (III) hydroxide, iron (III) oxide hydroxide, iron (III) oxide, or a combination thereof.

30. Use of the granule of claim 27 for removing substances from aqueous solution.

31. The use of claim 30, wherein said substances comprise contaminants.

32. The use of claim 31, wherein said contaminants comprise metal or heavy metal ions, halogens, nitrogen compounds, phosphorous compounds, sulphurous compounds, or small organic compounds with low molecular weight.

33. The use of claim 32, wherein said contaminants comprise Al, Sb, As(III), As(V), P, Ba, Cd, Ce, Cr, Co, Cu, Ga, Au, Fe, Pb, Mn, Hg, Mo, Ni, Pt, Se, Ag, Sn, W, U, Ra, Sr, Te, Zn, F, humic acid, or compounds thereof.

34. The use of claim 33, wherein said contaminants comprise As(III) or As(V).

35. A method for removing substances from aqueous solution, comprising the step of contacting said solution with
a titanic acid product having general formula TiO₂.nH₂O, wherein n=1 or 2, obtained by a process wherein titanic acid is precipitated from acidic hydrolysable titanium salt solution and said hydrolysable titanium salt solution is seeded with nuclei in the precipitation step in order to control the formation of the structure of said titanic acid product, or
a granule comprising a titanic acid product having general formula TiO₂.nH₂O, wherein n=1 or 2, obtained by a process wherein titanic acid is precipitated from acidic hydrolysable titanium salt solution and said hydrolysable titanium salt solution is seeded with nuclei in the precipitation step in order to control the formation of the structure of said titanic acid product.

36. The method of claim 35, wherein said substances comprise contaminants.

37. The method of claim 36, wherein said contaminants comprise metal or heavy metal ions, halogens, nitrogen compounds, phosphorous compounds, sulfurous compounds, or small organic compounds with low molecular weight.

38. The method of claim 37, wherein said contaminants comprise Al, Sb, As(III), As(V), P, Ba, Cd, Ce, Cr, Co, Cu, Ga, Au, Fe, Pb, Mn, Hg, Mo, Ni, Pt, Se, Ag, Sn, W, U, Ra, Sr, Te, Zn, F, humic acid, or compounds thereof.

39. The method of claim 38, wherein said contaminants comprise As(III) or As(V).

40. A filter assembly for removing substances from aqueous solution, comprising a casing comprising
a titanic acid product having general formula TiO₂.nH₂O, wherein n=1 or 2, obtained by a process wherein titanic acid is precipitated from acidic hydrolysable titanium salt solution and said hydrolysable titanium salt solution is seeded with nuclei in the precipitation step in order to control the formation of the structure of said titanic acid product, or
a granule comprising a titanic acid product having general formula TiO₂.nH₂O, wherein n=1 or 2, obtained by a process wherein titanic acid is precipitated from acidic hydrolysable titanium salt solution and said hydrolysable titanium salt solution is seeded with nuclei in the precipitation step in order to control the formation of the structure of said titanic acid product.
